(19) United States
(12) Patent Application Publication
(10) Pub. No.: US 2026/0249230 A1
(43) Pub. Date: Aug. 27, 2026

(54) GAS ADSORPTION CONCENTRATION APPARATUS

(71) Applicant: SHANGHAI SHENCHENG ENVIRONMENTAL PROTECTION EQUIPMENT & ENGINEERING CO., LTD., Shanghai (CN)

(72) Inventors: Chuanzhong ZHANG, Shanghai (CN); Dongjin YANG, Shanghai (CN); Jian CHEN, Shanghai (CN)

(21) Appl. No.: 18/872,654

(22) PCT Filed: Jun. 6, 2023
(86) PCT No.: PCT/CN2023/098584

§ 371 Date: Dec. 6, 2024

(30) Foreign Application Priority Data
Jun. 6, 2022 (CN) 202210721544.1
May 31, 2023 (CN) 202310634637.5

(51) Int. Cl. B01D 53/04

(52) U.S. Cl. CPC B01D 53/0423; B01D 2258/02; B01D 2259/40084; B01D 2259/4009; B01D 2259/41

(57) ABSTRACT

The present application relates to a gas adsorption concentration apparatus, including an adsorption section and a regeneration section. The adsorption section includes two or more adsorption modules each provided with a plurality of stages of adsorption units, the adsorption unit is configured as a fixed adsorption bed provided with an adsorbent, and when an adsorption gas containing adsorbates and basic components passes through the adsorption module, the adsorbates are adsorbed by the adsorbent in the adsorption unit. The regeneration section includes at least one desorption module provided with a plurality of stages of adsorption units, and when a hot desorption gas passes through the desorption module, the adsorbates in the adsorption unit are desorbed and carried out by the desorption gas. The adsorption units are transferred between the adsorption section and the regeneration section by means of an adsorption unit moving apparatus and circulate in adsorption and desorption processes. The gas adsorption concentration apparatus is capable of solving the problems of high flow resistance during an adsorption operation and low efficiency during a desorption operation of a high-flow-rate gas adsorption concentration apparatus.

### TECHNICAL FIELD

The present invention relates to a gas adsorption concentration apparatus, and more specifically, the present invention relates to a checkerboard-type gas adsorption concentration apparatus for concentrating volatile organic pollutants by adsorption.

### Background Art

“Space velocity” is technically borrowed a technical parameter of the catalytic reaction efficiency of a catalyst in the chemical field, and refers to an amount of gas treated by a unit volume of the catalyst per unit time under a specified condition, where in the field of environmental protection, the catalyst is replaced by an adsorbent, and the unit of the space velocity is usually m³/(m³ catalyst h), which may be simplified to be h⁻¹.

In a high-flow fixed-bed gas adsorption concentration apparatus, the flow resistance of the adsorption bed is an influential factor that significantly affects the energy consumption of the entire system. The flow resistance of the adsorption bed may be significantly reduced by reducing the thickness of the adsorption bed and lowering the gas flow velocity under the premise of maintaining a certain space velocity. In this case, the removal efficiency can still be guaranteed.

An adsorption separation apparatus disclosed in the Chinese invention patent document CN110013736A, which is also filed by the applicant of the present invention, includes three functional treatment modules, namely an adsorption sequence, a desorption sequence, and a thermal regeneration sequence, the adsorption sequence being composed of a plurality of adsorption units. The adsorption separation apparatus can achieve a very high removal efficiency, a very high pollutant concentration ratio, and a maximum thermal utilization efficiency in a treatment process of a pollutant variable-temperature adsorption method.

In the above technical solution, the adsorption sequence, the desorption sequence, and the thermal regeneration sequence are in a single series during an ordered flow of adsorption units. In specific applications, since an adsorbate concentration is usually low in the adsorption process, the ratio of an adsorption gas flow rate to a desorption gas flow rate is usually in tens to hundreds, or even up to thousands, which is exactly the technical advantage of a high concentration ratio of this apparatus.

However, in order to achieve the high concentration ratio and a flow balance of the adsorption units between all the adsorption function modules, the desorption sequence and the thermal regeneration sequence can only work with very low flow rates, resulting in low efficiency. The adsorption function module has a large gas volume and a high gas velocity, making the problem of high flow resistance more severe. The numbers of adsorption units distributed in the adsorption sequence, the desorption sequence, and the thermal regeneration sequence are close to each other, and apparatus resources are utilized in the desorption sequence and the thermal regeneration sequence with very low efficiencies.

Accordingly, there is an urgent need to design a gas adsorption concentration apparatus which is capable of solving the problems of high flow resistance during an adsorption operation and low efficiency during a desorption operation of a high-flow-rate gas adsorption concentration apparatus.

### SUMMARY OF INVENTION

The present application aims to provide a gas adsorption concentration apparatus capable of solving the problems of high flow resistance during an adsorption operation and low efficiency during a desorption operation.

The gas adsorption concentration apparatus according to the present invention includes an adsorption section and a desorption section, wherein the adsorption section comprises two or more adsorption modules each provided with a plurality of stages of adsorption units, the adsorption unit is configured as a fixed adsorption bed provided with an adsorbent, and when an adsorption gas containing adsorbates and basic components passes through the adsorption module, the adsorbates are adsorbed by the adsorbent in the adsorption unit; the regeneration section comprises at least one desorption module provided with a plurality of stages of adsorption units, and when a hot desorption gas passes through the desorption module, the adsorbates in the adsorption unit are desorbed and carried out by the desorption gas. The gas adsorption concentration apparatus is characterized in that the adsorption units are transferred between the adsorption section and the regeneration section by means of an adsorption unit moving device and circulated in adsorption and desorption processes.

In a preferred embodiment, when the adsorption section comprises a plurality of adsorption modules, the adsorption modules may be arranged in a parallel connection relationship.

In another preferred embodiment, the gas adsorption concentration apparatus may further comprise a connection pipeline provided with a movable joint, wherein the connection pipeline realizes a series connection of the adsorption units in each adsorption module of the adsorption section and a parallel connection between all the adsorption modules.

Alternatively, the connection pipeline may realize a series connection of the adsorption units in each desorption module of the regeneration section and a parallel connection between all the desorption modules.

In yet another preferred embodiment, the adsorption unit moving device may have a pattern of a checkerboard-type transport device, the checkerboard-type transport device consists of a plurality of power support wheel moving disks fixed on the ground in a checkerboard-type distribution and moving rail seats fixed on the adsorption units and matching with the power support wheel moving disks, and the moving rail seats carrying the adsorption units are moved between the power support wheel moving disks in two directions perpendicular to each other, thereby realizing the transfer of the adsorption units between the adsorption section and the regeneration section and the transfer of the adsorption units inside the adsorption module and the desorption module.

Preferably, a support wheel of the power support wheel moving disk may be provided with a hydraulic lift cylinder, and the hydraulic lift cylinder realizes docking and undocking between an adsorption unit joint and the movable joint of the connection pipeline below the adsorption unit joint by controlling lifting of the support wheel.

In yet another preferred embodiment, the desorption module may be a variable-temperature variable-pressure desorption device. In this embodiment, the desorption module is changed from a variable-temperature desorption device that uses a hot gas for desorption and destroys an organic pollutant using a thermal oxidizing incinerator to the variable-temperature variable-pressure desorption device that uses negative pressure and temperature-rising negative pressure for desorption and recovers an organic pollutant through condensation.

In yet another preferred embodiment, the gas adsorption concentration apparatus is further provided with adsorption unit storage sections respectively arranged on two sides of the adsorption section and the regeneration section, where the adsorption unit storage section removes a saturated adsorption unit that has completed saturated adsorption from the adsorption section, and/or removes a blank adsorption unit that has completed desorption regeneration from the connection pipeline of the regeneration section and re-adds the blank adsorption unit into the connection pipeline as needed.

In an optimal embodiment, the adsorption section may include a housing, an adsorption gas inlet, an adsorption gas outlet, an adsorption array assembly, an adsorption unit transfer-in site, and an adsorption unit transfer-out site; the adsorption array assembly is provided with a plurality of juxtapositional adsorption modules each including at least one layer of the adsorption units; the adsorption array assembly divides a space enclosed by the housing into an inlet gas distribution box and an outlet gas collection box; the adsorption gas inlet is in communication with the inlet gas distribution box; the adsorption gas outlet is in communication with the outlet gas collection box; and a mechanical support and transfer device, as a constituent part of the adsorption array assembly, supports a movement of the adsorption module at an adsorption function site, moves the adsorption unit that has completed adsorption from the adsorption function site in the adsorption module to the adsorption unit transfer-out site, and moves the adsorption unit that has completed regeneration treatment from the adsorption unit transfer-in site to the adsorption function site in the adsorption module.

Preferably, the adsorption module may include a plurality of layers of the adsorption units; an end of the adsorption module located on a side of the inlet gas distribution box is referred to as a head end, and an end located on a side of the outlet gas collection box is referred to as a tail end; the mechanical support and transfer device moves the adsorption unit from the head end to the adsorption unit transfer-out site and moves the adsorption unit that has completed the regeneration treatment from the adsorption unit transfer-in site to the tail end; and the adsorption unit moves from the tail end to the head end in the adsorption module.

Preferably, the desorption module of the regeneration section may include a desorption module housing, a desorption gas inlet, a desorption gas outlet, a desorption gas heater, an adsorption unit desorption column, an adsorption unit heat recovery column, an adsorption unit receiving channel, an adsorption unit sending channel, and a corresponding mechanical moving device; the desorption gas from a desorption gas supply device passes through the desorption module according to an order of the desorption gas inlet [symbol] the adsorption unit heat recovery column [symbol] the desorption gas heater [symbol] the adsorption unit desorption column [symbol] the desorption gas outlet, to reach a desorption gas treatment device; and the mechanical moving device moves the adsorption unit in the desorption module according to an order of the adsorption unit receiving channel [symbol] the adsorption unit desorption column [symbol] the adsorption unit heat recovery column [symbol] the adsorption unit sending channel.

Preferably, the adsorption unit receiving channel and the adsorption unit sending channel of the regeneration section may be respectively docked with the adsorption unit transfer-out site and the adsorption unit transfer-in site of the adsorption section, the adsorption gas and the desorption gas are isolated from each other at docking positions by means of transition chambers, and the transition chambers are connected between the adsorption section and the regeneration section and each provided with valves on two sides.

Preferably, the adsorption array assembly may have a sprocket structure, and each adsorption module acts as an attachment of a link of the sprocket structure and rotates cyclically on the sprocket structure.

Preferably, the number of links of the sprocket structure may be determined based on a flow rate of the adsorption gas, to adjust the number of the adsorption modules.

Preferably, the desorption module may be set to be an inverted U-shaped structure, with the desorption gas heater located at an upper portion thereof, and the adsorption unit desorption column and the adsorption unit heat recovery column respectively located at lower portions on two sides thereof.

In addition, the regeneration section may include two desorption modules; the desorption gas may be pyrolyzed with a regenerative thermal oxidizer (RTO), and heat generated in the RTO is transported to the desorption module as a heat source for desorption through a heat exchange pipeline; and the adsorbent loaded into the adsorption unit may be in an industrially common granular form.

The gas adsorption concentration apparatus according to the present invention has the following beneficial effects:
(i) The problems of high flow resistance during an adsorption operation and low efficiency during a desorption operation of a high-flow-rate gas adsorption concentration apparatus are solved.
(ii) The number of links may be determined based on the flow rate of the adsorption gas, so that a flow load of an apparatus can be greatly changed without changing specifications of main components of the apparatus.
(iii) A regeneration treatment capacity of the desorption module and an adsorption treatment capacity of the adsorption module can be optimally configured according to concentration ratios for treatment processes of different adsorption gases.
(iv) For the adsorption concentration apparatus of a determined configuration, it is possible to adjust a circulation period of the adsorption module of the adsorption section and a desorption flow rate of the desorption module, to adapt to great changes in the flow rate and concentration of the adsorption gas; and for the apparatus provided with a plurality of desorption modules, it is also possible to choose to enable different numbers of desorption modules, to adapt to great changes in the flow rate and concentration of the adsorption gas.
(v) Meanwhile, the adsorption concentration apparatus inherits the technical advantages such as high efficiency and energy saving in the desorption regeneration process of the adsorption separation apparatus disclosed in the patent document CN110013736A.
(vi) An adsorption function and a desorption function of the adsorption concentration apparatus are temporally separable by designing the adsorption unit storage section. In this way, a desorption and destruction process of an emission source with high concentration, large flow rate, and intermittent operation can operate continuously, without entering a high energy consumption, unstable state during switch-on and off, thus achieving the purposes of energy saving and consumption reduction.

The present application is further described below with reference to the drawings and embodiments.

### DESCRIPTION OF THE DRAWINGS

FIG. 1a is a schematic diagram of a basic structure of a gas adsorption concentration apparatus according to the present invention;

FIG. 1b is a schematic top view of power support wheel moving disks of an adsorption unit moving device in the apparatus of FIG. 1a;

FIG. 2 is a schematic diagram of a structural relationship of a power support wheel moving disk, a moving rail seat, and an adsorption unit pipeline docking device of an adsorption unit moving device;

FIG. 3a illustrates a gas adsorption concentration apparatus provided with two adsorption modules and one desorption module;

FIG. 3b is a schematic top view of power support wheel moving disks of an adsorption unit moving device in the apparatus of FIG. 3a;

FIG. 4 illustrates a gas adsorption concentration apparatus provided with four adsorption modules and one desorption module;

FIG. 5 illustrates a gas adsorption concentration apparatus provided with a variable-pressure variable-temperature desorption module;

FIG. 6 illustrates a gas adsorption concentration apparatus provided with six adsorption modules and two desorption modules;

FIG. 7 illustrates a gas adsorption concentration apparatus provided with an adsorption unit storage section;

FIG. 8 is a comprehensive schematic diagram of a gas adsorption concentration apparatus having a composite array configuration, which illustrates flow directions of an adsorption gas and a desorption gas and an adsorbate transfer process, in the figure, the characters “+” indicate adsorbate contents, the large hollow bilateral arrows indicate the flow direction of the adsorption gas, and the small hollow arrows indicate the flow direction of the desorption gas;

FIG. 9 is a schematic diagram of a configuration of the apparatus shown in FIG. 8, which illustrates a circulation process of adsorption units, in the figure, the hollow unilateral arrows indicate the transfer direction of the adsorption units;

FIG. 10 is a schematic diagram of a configuration of the apparatus shown in FIG. 8, in the figure, the regeneration section is provided with two desorption modules;

FIG. 11 is a partial schematic diagram of the apparatus shown in FIG. 8, which illustrates a heat distribution of the desorption module during a desorption process;

FIG. 12 is a partial schematic diagram of the apparatus shown in FIG. 8, which illustrates an adsorption unit filled with an adsorbent filler;

FIG. 13 is a schematic diagram of a configuration of the apparatus shown in FIG. 8, which illustrates a combination manner with an RTO;

FIG. 14 is a three-dimensional view of a gas adsorption concentration apparatus having a composite array configuration, where a housing and some internal components are partially cutout;

FIG. 15 is a three-dimensional view of the apparatus shown in FIG. 14, where a housing of the adsorption section is removed, and a housing of the desorption module and some components of the adsorption section are partially cut out;

FIG. 16 is a three-dimensional view of an adsorption section of the apparatus shown in FIG. 14, where a housing of the adsorption section and a side annular seal are removed;

FIG. 17 is a three-dimensional view of an adsorption section of the apparatus shown in FIG. 14, which illustrates an adsorption unit circulation mechanical structure of an adsorption section;

FIG. 18 is a partial three-dimensional view of the apparatus shown in FIG. 14, which illustrates a functional configuration for transferring adsorption units between an adsorption section and a regeneration section and valve settings of transition chambers; and

FIG. 19 is a partial three-dimensional view of the apparatus shown in FIG. 14, which illustrates valves of transition chambers.

### PREFERRED EMBODIMENTS

### Embodiment 1: Gas Adsorption Concentration Apparatus With Basic Functional Settings

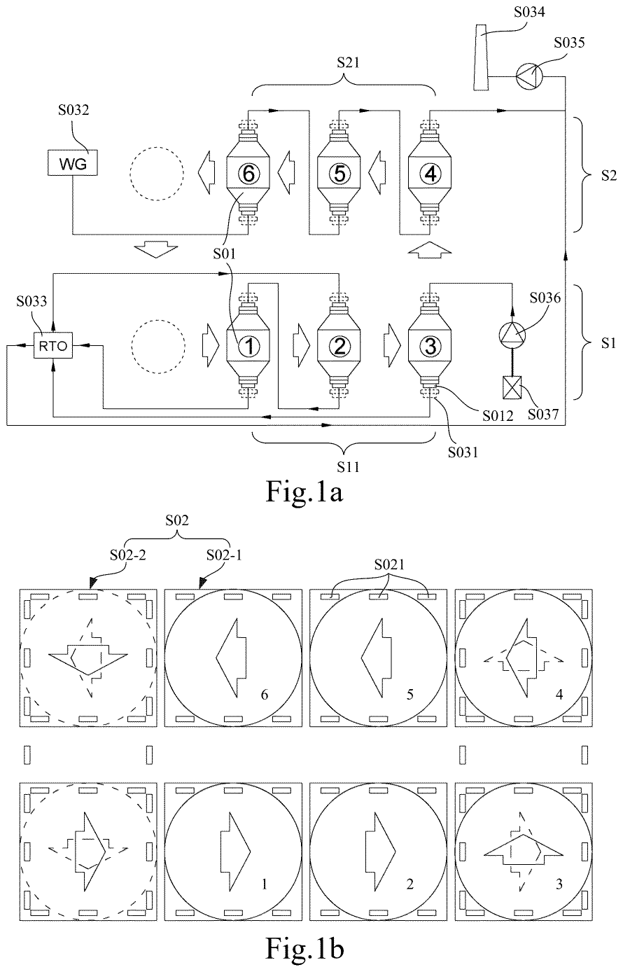

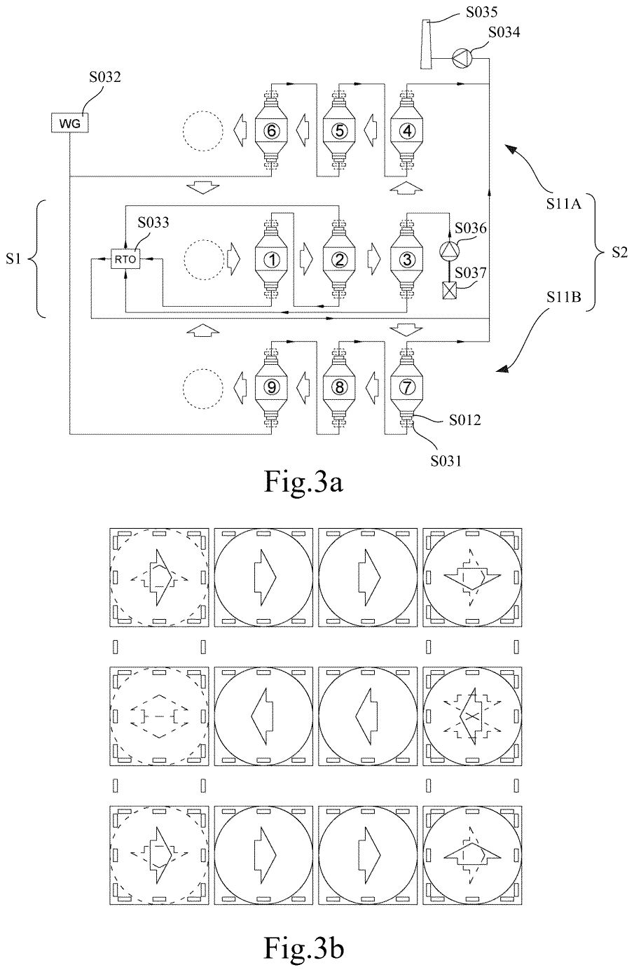

With reference to FIGS. 1a, 1b, and 3, the gas adsorption concentration apparatus according to the present invention includes an adsorption section S1 and a regeneration section S2. The adsorption section S1 includes an adsorption module S11 provided with three stages of adsorption units S01. The regeneration section S2 includes a desorption module S21 provided with three stages of adsorption units S01, where two stages providing a desorption function, and one stage providing a heat recovery function. The adsorption units S01 are transferred between the adsorption section S1 and the regeneration section S2 by means of an adsorption unit moving device and circulated during adsorption and desorption processes.

The adsorption unit moving device has a pattern of a checkerboard-type transport device. The checkerboard-type transport device consists of a plurality of power support wheel moving disks S02 fixed on the ground in a checkerboard-type distribution and moving rail seats S011 fixed on the adsorption units S01 and matching with the power support wheel moving disks S02. The power support wheel moving disks S02 are divided into two types, namely a single-rail support wheel moving disk S02-1 and a double-rail support wheel moving disk S02-2. The single-rail support wheel moving disk S02-1 is provided with a total of six support wheels S021 in two groups, and thus can only carry the adsorption unit S01 to move in a one-dimensional direction, namely a horizontal direction or a vertical direction, where the movement in a one-dimensional direction is marked with a single hollow arrow in FIG. 1b. The double-rail support wheel moving disk S02-2 is provided with a total of twelve support wheels S021 in four groups, and thus can carry the adsorption unit S01 to move in a two-dimensional direction, namely a horizontal direction and a vertical direction, where the movement in a two-dimensional direction is marked with two hollow arrows in FIG. 1b.

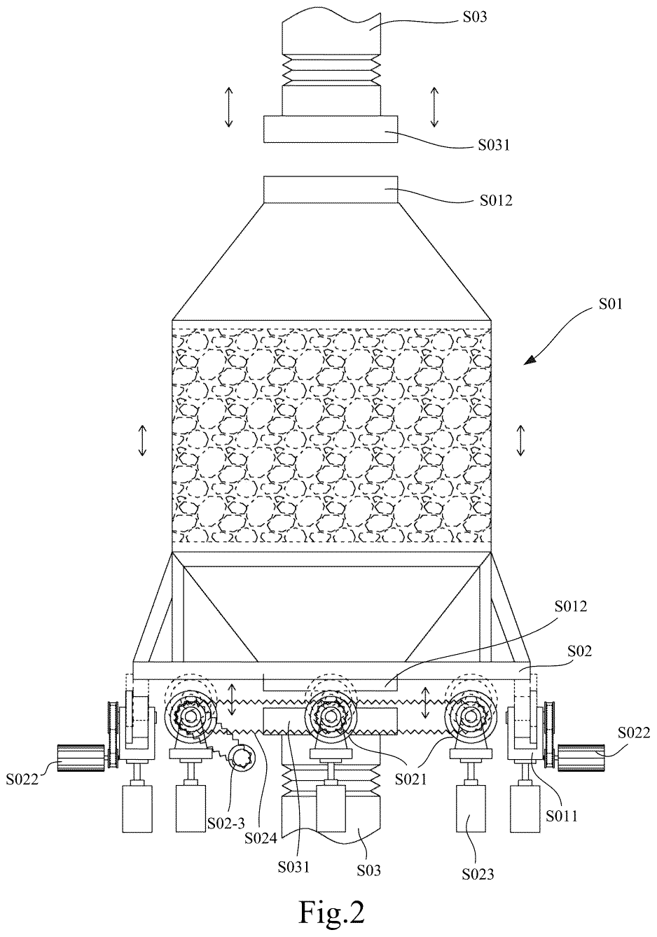

As shown in FIG. 2, the support wheels S021 of the two types of power support wheel moving disks S02 described above are each provided with a hydraulic lift cylinder S022, which functions to realize docking and undocking between an adsorption unit joint S012 and a movable joint S031 below the adsorption unit joint by controlling lifting of the support wheel S021. In addition, a conversion between horizontal and vertical movements of the adsorption unit S01 is also realized on the double-rail support wheel moving disk S02-2. Movements of all the groups of support wheels S021 of the power support wheel moving disk S02 are driven by a motor S023 and synchronized by means of transmission with a belt S024. A transition support wheel S02-3 is provided between the widely-spaced power support wheel moving disks S02 over which the adsorption unit S01 needs to cross, to assist the power support wheel moving disks S02 in steadily transporting the adsorption unit S01.

In the above-mentioned gas adsorption concentration apparatus, a connection pipeline S03 provided with the movable joint S031 realizes series connections of the adsorption units S01 in each adsorption module/desorption module of the adsorption/regeneration section and parallel connections between all the adsorption modules/desorption modules.

As shown in FIG. 1a, in this embodiment, components such as a waste gas collection and transfer device (WG) S032, a regenerative thermal oxidizer S033, a waste gas blower S034, a discharge chimney S035, a desorption blower S036, and a desorption gas filtering device S037 are also provided externally.

The dashed line circles in FIGS. 1a and 1b indicate blank stations where the adsorption unit S01 is not connected to the connection pipeline S03 during circulation, which are only for a temporary stop.

During operation, after a polluted waste gas from the waste gas collection and transfer device S032 sequentially passes through three adsorption units labeled with the numbers 6, 5, and 4 in the figures, an organic pollutant is adsorbed and retained by an adsorbent in these adsorption units, and then discharged up to standard by means of the waste gas blower S034 and the discharge chimney S035. A desorption gas from the desorption gas filtering device S037 and the desorption blower S036 is preheated by the adsorption unit labeled with the number 3 in the figure, further heated by the regenerative thermal oxidizer S033, then sequentially passes through the adsorption units labeled with the numbers 2 and 1 in the figure, carries a desorbed organic pollutant into the regenerative thermal oxidizer S033 again, and then enters the discharge chimney S035 after oxidizing and incineration for discharge up to standard. When the adsorption unit labeled with the number 6 in the figure reaches a dynamic saturation state after adsorbing a sufficient amount of organic pollutants, the adsorption unit joints S012 of all the adsorption units S01 are undocked with the movable joints S031, and all the adsorption units S01 are sequentially moved in a direction indicated by the arrows in the figure. As a result, the adsorption unit labeled with the number 6 in the figure is moved to an original position of the adsorption unit labeled with the number 1 in the figure, the adsorption unit labeled with the number 5 in the figure is moved to an original position of the adsorption unit labeled with the number 6 in the figure, and so on, until the adsorption unit joints S012 of all the adsorption units S01 are docked with the movable joints S031, the whole apparatus starts functional operation of a next time period.

This embodiment presents the most basic functional setting of the checkerboard-type gas adsorption concentration apparatus, which is mainly used to illustrate a functional principle and cannot yet realize the various technical advantages of the present invention listed in the description.

### Embodiment 2: A Gas Adsorption Concentration Apparatus Provided With Two Adsorption Modules and One Desorption Module

With reference to FIGS. 3a and 3b, one adsorption module is added into the apparatus of Embodiment 1. The adsorption module S11A and the adsorption module S11B are in a parallel connection relationship and operate simultaneously, but operation time periods thereof need to be staggered, i.e., the two adsorption modules S11A and S11B alternately exchange adsorption units with the desorption module S21 at uniform time intervals. When the most upstream adsorption unit (labeled with the number 6 in the figure) of the adsorption module S11A is saturated, the adsorption unit joints S012 of all the adsorption units S01 of the adsorption module S11A and the desorption module S21 are undocked with the movable joints S031, and all the adsorption units S01 are moved in an anticlockwise direction indicated by the arrows in the figure. As a result, the adsorption unit labeled with the number 6 in the figure is moved to the original position of the adsorption unit labeled with the number 1 in the figure, and the adsorption unit labeled with the number 5 in the figure is moved to the original position of the adsorption unit labeled with the number 6 in the figure. When the most upstream adsorption unit (labeled with the number 9 in the figure) of the adsorption module S11B is saturated, the adsorption unit joints S012 of all the adsorption units S01 of the adsorption module S11B and the desorption module S21 are undocked with the movable joints S031, and all the adsorption units S01 are moved in a clockwise direction indicated by the arrows in the figure. As a result, the adsorption unit labeled with the number 9 in the figure is moved to the original position of the adsorption unit labeled with the number 6 in the figure in a last switch, and the adsorption unit labeled with the number 8 in the figure is moved to an original position of the adsorption unit labeled with the number 9 in the figure. Such operation is carried out cyclically. During operation, flow directions of the waste gas and the desorption gas in the connection pipeline S03 are also as shown in the figure.

### Embodiment 3: A Gas Adsorption Concentration Apparatus Provided With Four Adsorption Modules and One Desorption Module

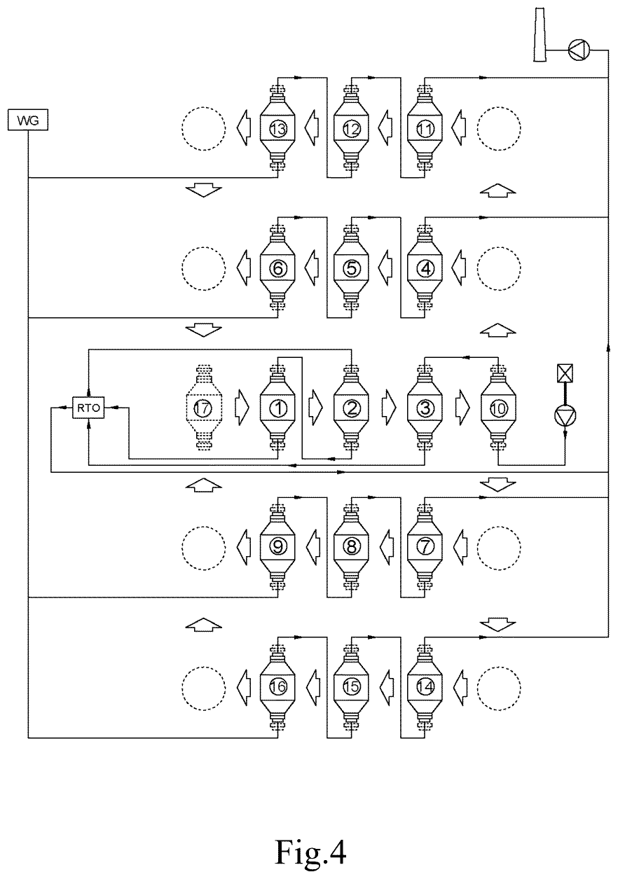

With reference to FIG. 4, other two adsorption modules are added into the apparatus of Embodiment 2, and one heat recovery adsorption unit and one adsorption unit to be desorbed are also added, so as to further improve the heat utilization efficiency of the apparatus in the desorption process without increasing the ground coverage and complexity of the apparatus, and eliminate waiting time for moving the adsorption unit from the adsorption module to the desorption module during switch of an adsorption unit in the desorption module.

All the adsorption modules are in a parallel connection relationship and operate simultaneously, while operation time periods thereof are sequentially staggered uniformly, i.e., the four adsorption modules alternately exchange adsorption units with the desorption module at uniform time intervals.

### Embodiment 4: A Gas Adsorption Concentration Apparatus Provided With a Variable-Pressure Variable-Temperature Desorption Module

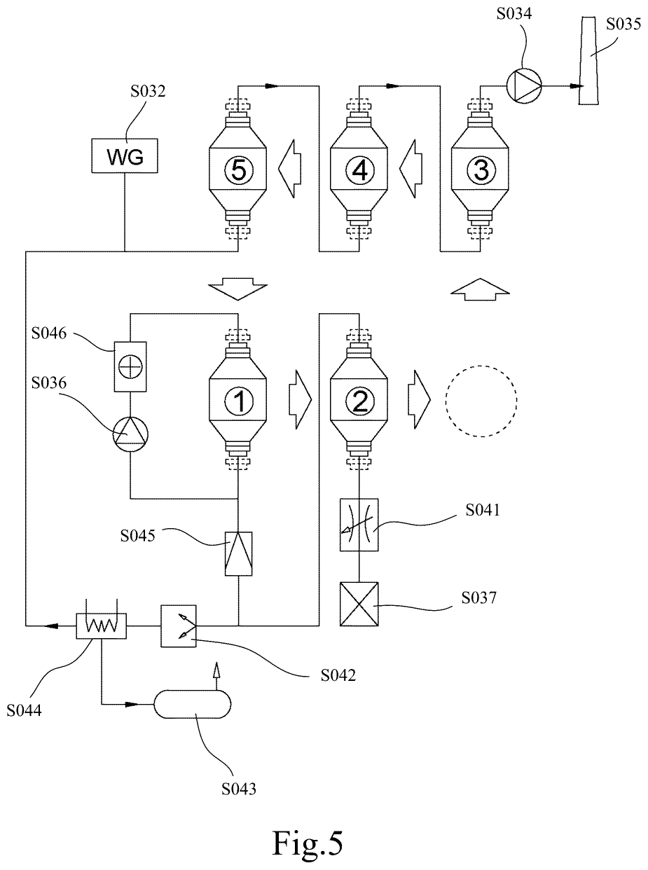

With reference to FIG. 5, the desorption module of the apparatus of Embodiment 1 is changed from a variable-temperature desorption apparatus that uses a hot gas for desorption and destroys an organic pollutant using a thermal oxidizing incinerator to the variable-temperature variable-pressure desorption device that uses negative pressure and temperature-rising negative pressure for desorption and recovers an organic pollutant via condensation.

The adsorption module of this apparatus has no essential difference from that in Embodiment 1.

The desorption module of this apparatus includes two adsorption units, where the adsorption unit labeled with the number 2 in the figure is in a negative-pressure desorption mode, and has peripheral functional components including the desorption gas filtering device S037, a throttling valve S041, a vacuum pump S042, a liquid storage tank S043, and a condenser S044. The adsorption unit labeled with the number 1 in the figure is in a heating negative-pressure desorption mode, and has peripheral functional components including a pressure relief valve S045, the desorption blower S036, and a gas heater S046. An organic waste gas desorbed in the above two modes is liquefied by the condenser S044 and then enters the storage tank S043 for storage and usage, and a non-condensable gas which still contains an organic pollutant returns to a waste gas inlet pipeline.

The apparatus is also suitable for a design in which a plurality of adsorption modules correspond to one regeneration desorption module.

### Embodiment 5: A Gas Adsorption Concentration Apparatus Provided With Six Adsorption Modules and Two Desorption Modules

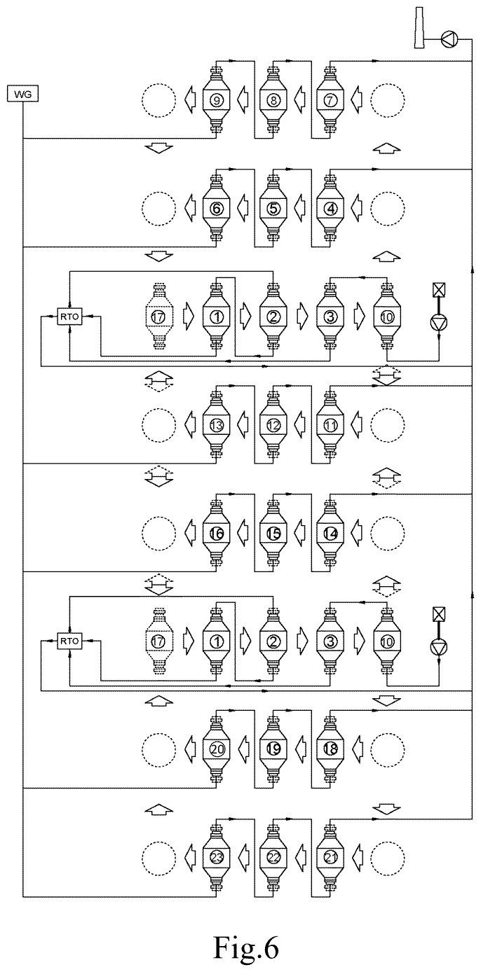

With reference to FIG. 6, the apparatus is provided with six adsorption modules and two desorption modules. Specific settings of a single adsorption module and a single desorption module have no difference from those in Embodiment 3, where the six adsorption modules are in a parallel connection relationship, and the adsorption units can circulate among the six adsorption modules and the two desorption modules. One of the desorption modules can be disabled when the concentration of the waste gas decreases, to further increase the concentration ratio of the waste gas and reduce the desorption energy consumption.

### Embodiment 6: A Gas Adsorption Concentration Apparatus Provided With an Adsorption Unit Storage Section

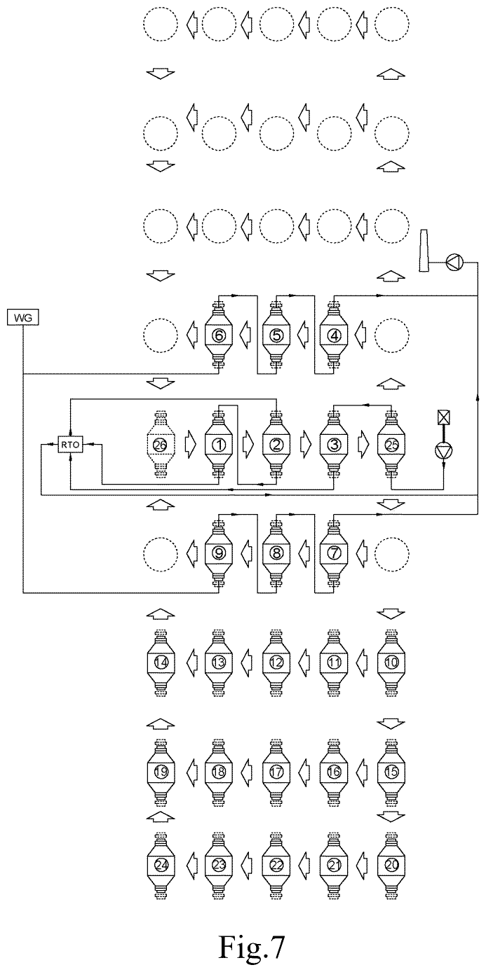

With reference to FIG. 7, one heat recovery adsorption unit and one adsorption unit to be desorbed are added into the apparatus of Embodiment 2, the functions of which have been described in Embodiment 3, and the adsorption unit storage section is provided on the basis of Embodiment 3. The adsorption unit storage section is divided into two portions respectively arranged on two sides of the adsorption section S1 and the regeneration section S2. An adsorption unit transport mode in the adsorption section S1 may be the same as those in the adsorption section S1 and the regeneration section S2.

An adsorption function and a desorption function of the adsorption concentration apparatus are temporally separable by designing the adsorption unit storage section. For example, one function operates continuously while the other function operates intermittently, or both functions operate intermittently but operate in completely different time periods, and so on. In specific applications, when the desorption function works continuously and the adsorption function works intermittently, a desorption and destruction process of an emission source with high concentration, large flow rate, and intermittent operation can operate continuously, without entering a high energy consumption, unstable state during switch-on and off, thus achieving the purposes of energy saving and consumption reduction.

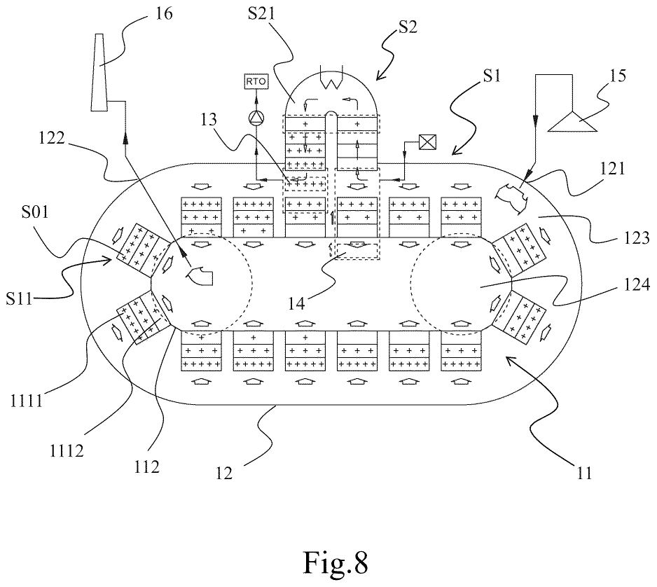

With reference to FIGS. 8 to 13, a plurality of embodiments of another gas adsorption concentration apparatus are shown. As shown in FIG. 8, the adsorption section S1 includes a housing 12, an adsorption gas inlet 121, an adsorption gas outlet 122, an adsorption array assembly 11, an adsorption unit transfer-in site 13, and an adsorption unit transfer-out site 14. The adsorption array assembly 11 is provided with two or more juxtapositional adsorption modules S11 each including at least one layer of the adsorption units S01, to divide a space enclosed by the housing 12 into an inlet gas distribution box 123 and an outlet gas collection box 124. The adsorption gas inlet 121 is in communication with the inlet gas distribution box 123, and the adsorption gas outlet 122 is in communication with the outlet gas collection box 124. During operation of the apparatus, the adsorption gas from a gas collection device 15 enters the inlet gas distribution box 123 via the adsorption gas inlet 121, and passes through the adsorption modules S11 on the adsorption array assembly 11 in parallel, resulting in a treated clean gas entering the outlet gas collection box 124 and then being discharged to the discharge chimney 16 via the adsorption gas outlet 122. The adsorption array assembly 11 further includes a mechanical support and transfer device 112, which functions to mechanically support each adsorption module S11 to form a complete shield that isolates the inlet gas distribution box 123 from the outlet gas collection box 124, sequentially moves the adsorption unit S01 that has completed adsorption from the adsorption function site in the adsorption module S11 to the adsorption unit transfer-out site 14, and moves the adsorption unit S01 that has completed regeneration treatment from the adsorption unit transfer-in site 13 to the adsorption function site in the adsorption module S11.

The adsorption module S11 is optimized by including a plurality of layers of the adsorption units S01, where an end of the adsorption module S11 located on a side of the inlet gas distribution box 123 is referred to as a head end 1111, and an end located on a side of the outlet gas collection box 124 is referred to as a tail end 1112. The mechanical support and transfer device 112 moves the adsorption unit S01 from the head end 1111 to the adsorption unit transfer-out site 14 and moves the adsorption unit S01 that has completed the regeneration treatment from the adsorption unit transfer-in site 13 to the tail end 1112. The adsorption unit S01 moves from the tail end 1112 to the head end 1111 in the adsorption module S11.

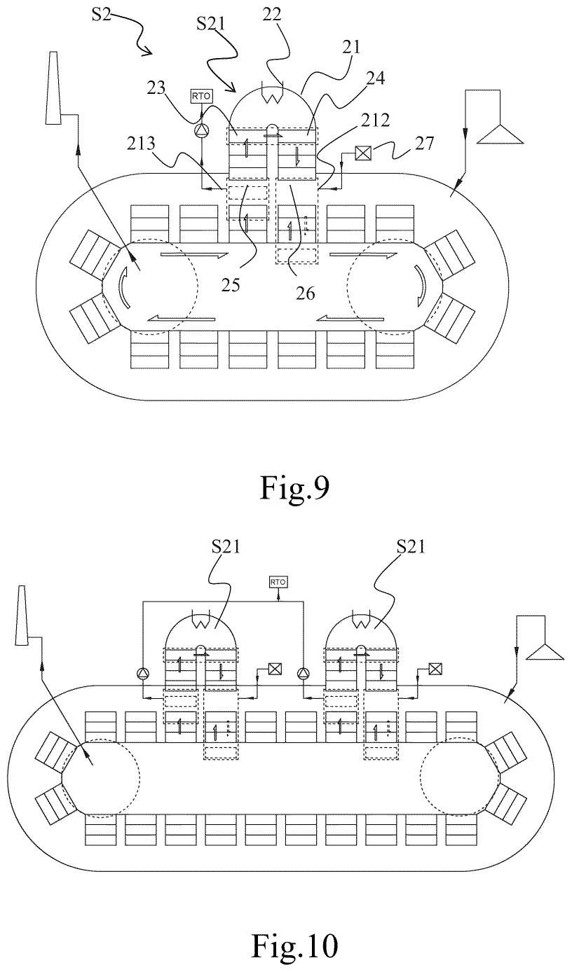

With continued reference to FIGS. 8 and 9, the regeneration section S2 includes at least one desorption module S21 provided with a plurality of layers of the adsorption units S01. Each desorption module S21 includes a desorption module housing 21, a desorption gas inlet 212, a desorption gas outlet 213, a desorption gas heater 22, an adsorption unit desorption column 23, an adsorption unit heat recovery column 24, an adsorption unit receiving channel 25, an adsorption unit sending channel 26, and a corresponding mechanical moving device. The adsorption unit heat recovery column 24 and the adsorption unit receiving channel 25 are composed of a plurality of stacked adsorption units S01. The desorption gas from a desorption gas supply device 27 passes through a regeneration module according to an order of the desorption gas inlet 212 [symbol] the adsorption unit heat recovery column 24 [symbol] the desorption gas heater 22 [symbol] the adsorption unit desorption column 23 [symbol] the desorption gas outlet 213, to reach a desorption gas treatment device (an RTO is used as an example in the figure). The mechanical moving device moves the adsorption unit S01 in the desorption module S21 according to an order of the adsorption unit receiving channel 25 [symbol] the adsorption unit desorption column 23 [symbol] the adsorption unit heat recovery column 24 [symbol] the adsorption unit sending channel 26.

The adsorption unit receiving channel 25 and the adsorption unit sending channel 26 of the regeneration section S2 are respectively docked with the adsorption unit transfer-out site 14 and the adsorption unit transfer-in site 13 of the adsorption section S1. The adsorption gas and the desorption gas are isolated from each other at docking positions by means of transition chambers, and the transition chambers are connected between the adsorption section S1 and the regeneration section S2 and each provided with valves on two sides.

The adsorption array assembly 11 may have a sprocket structure. Each adsorption module S11 acts as an attachment of a link of the sprocket structure and rotates cyclically on the sprocket structure.

The number of links of the sprocket structure may be determined based on a flow rate of the adsorption gas to adjust the number of the adsorption modules S11. With continued reference to FIG. 10, the regeneration section S2 may be provided with two or more desorption modules S21. When a plurality of desorption modules S21 operate simultaneously, it is necessary to coordinate the distribution of the adsorption units S11 transferred out from the adsorption section S1 among the desorption modules S21 according to an appropriate interval and transfer the adsorption units back to the adsorption section S1 in the same manner.

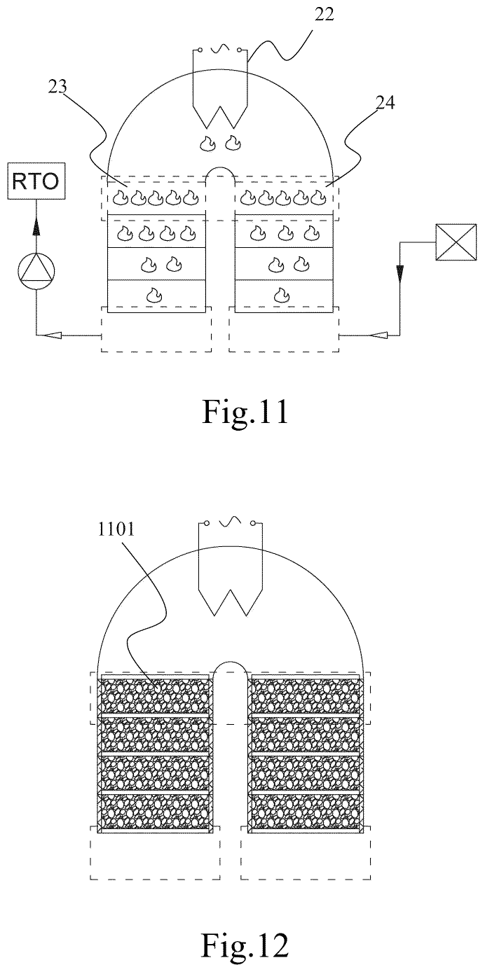

With reference to FIGS. 11 and 12, the desorption module S21 may be set to be an inverted U-shaped structure, with the desorption gas heater 22 located at an upper portion thereof, and the adsorption unit desorption column 23 and the adsorption unit heat recovery column 24 respectively located at lower portions on two sides thereof. The desorption gas entering the desorption module S21 is preheated by absorbing heat in the adsorption unit S01 that has been completed desorption in the adsorption unit heat recovery column 24, and then heated by an air heater to a predetermined desorption temperature. Then the adsorption unit desorption column 23 is heated for desorption, while the desorption gas is cooled to carry adsorbates out from the desorption module S21. Similarly, the adsorption unit S01 passing through the desorption module S21 undergoes the processes of temperature rising and then dropping. The two processes fully demonstrate that the desorption regeneration process is an energy efficient process.

The adsorption unit S01 may be filled with an adsorbent 1101 in an ordinary industrial granular form, to lower the requirement for the form of the adsorbent in commercial promotion, thereby reducing the difficulties in technical implementations and saving the manufacturing costs of the apparatus.

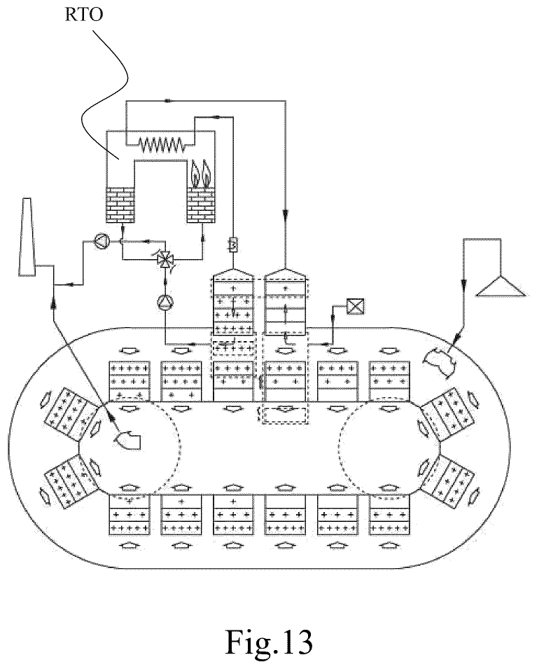

With reference to FIG. 13, the desorption gas discharged by the apparatus during the desorption operation may be pyrolyzed by means of the RTO. When the amount of heat contained in the desorption gas exceeds that required to maintain operation of the RTO, excess heat generated in the RTO may be used, by means of a heat exchange pipeline, as a heat source for heating the desorption gas in the desorption module S21.

### Embodiment 7: A Gas Adsorption Concentration Apparatus Having a Sprocket Structure

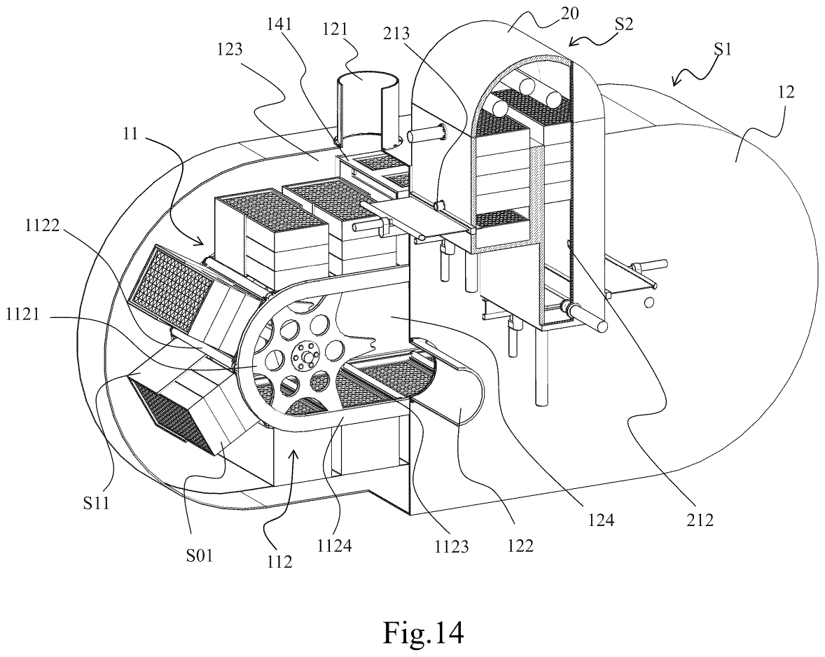

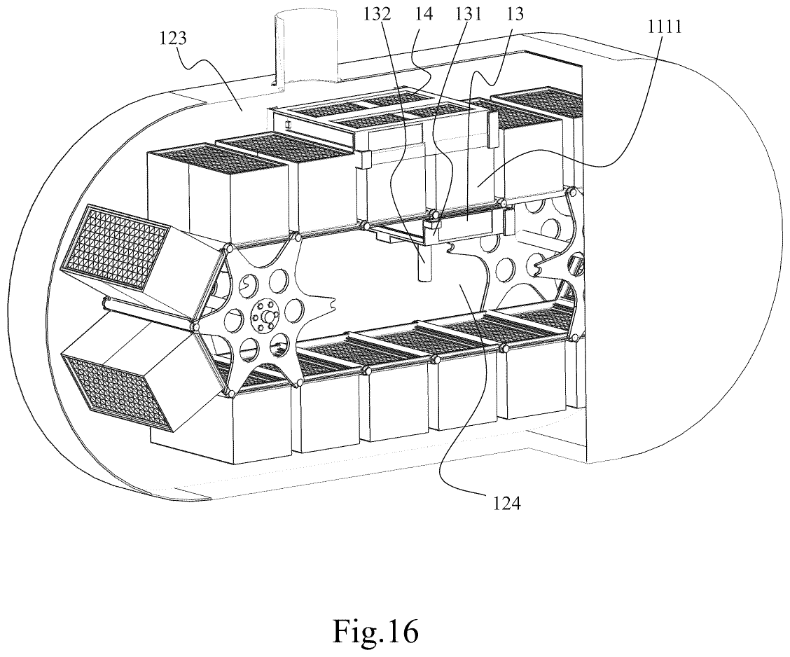

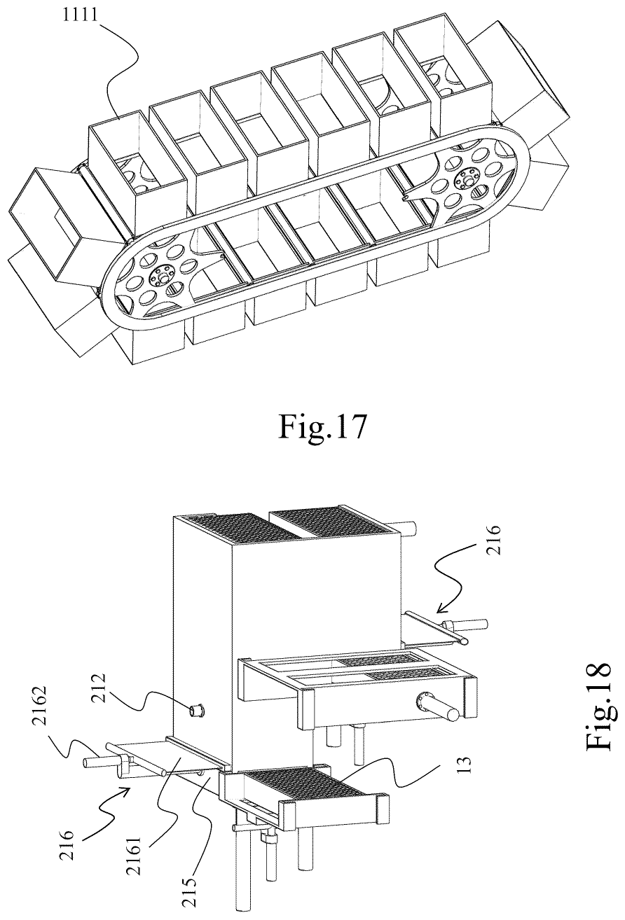

With reference to FIGS. 14 to 17, the adsorption section S1 includes the housing 12, the adsorption gas inlet 121, the adsorption gas outlet 122, the adsorption array assembly 11, the adsorption unit transfer-in site 13, and the adsorption unit transfer-out site 14. The adsorption array assembly 11 is provided with twelve juxtapositional adsorption modules S11 each including three layers of the adsorption units S01. The adsorption array assembly 11 divides the space enclosed by the housing 12 into the inlet gas distribution box 123 and the outlet gas collection box 124. The adsorption gas inlet 121 is in communication with the inlet gas distribution box 123, and the adsorption gas outlet 122 is in communication with the outlet gas collection box 124. The mechanical support and transfer device 112 of the adsorption array assembly 11 has a sprocket structure mainly including two pairs of sprockets 1121 and a chain 1122 connecting the two pairs of sprockets 1121 and rotating around the sprockets, where each adsorption module S11 acts as an attachment structure of one link of the chain and corresponds to each link. A flexible seal 1123 is provided between the links, and an annular seal 1124 is provided between the chain and the housing 12 of the adsorption section S1, where the annular seal 1124 rotates synchronously with the chain 1122.

The two seals function to form a complete shield between the adsorption modules S11 and between the adsorption array assembly 11 and the housing 12, to isolate the inlet gas distribution box 123 from the outlet gas collection box 124. The adsorption unit transfer-in site 13 is provided in a space of the outlet gas collection box 124 below an upper half of the chain of the adsorption array assembly 11 and used to transfer the adsorption unit S01 that has completed desorption regeneration into the adsorption array assembly 11. The adsorption unit transfer-out site 14 is provided in a space of the inlet gas distribution box 123 above the upper half of the chain and used to transfer the adsorption unit S01 that has completed adsorption out from the adsorption array assembly 11. A tray 131 that functions to limit the position of the adsorption module S11 and a hydraulic push rod 132 for pushing the adsorption module S11 into an adsorption module sleeve 1111 are provided at the adsorption unit transfer-in site 13. A cover plate 141 functions to limit the position of the adsorption module S11 and a hydraulic push rod 142 for pushing the adsorption module S11 out from the adsorption array assembly 11 into the desorption module S21 are provided at the adsorption unit transfer-out site 14.

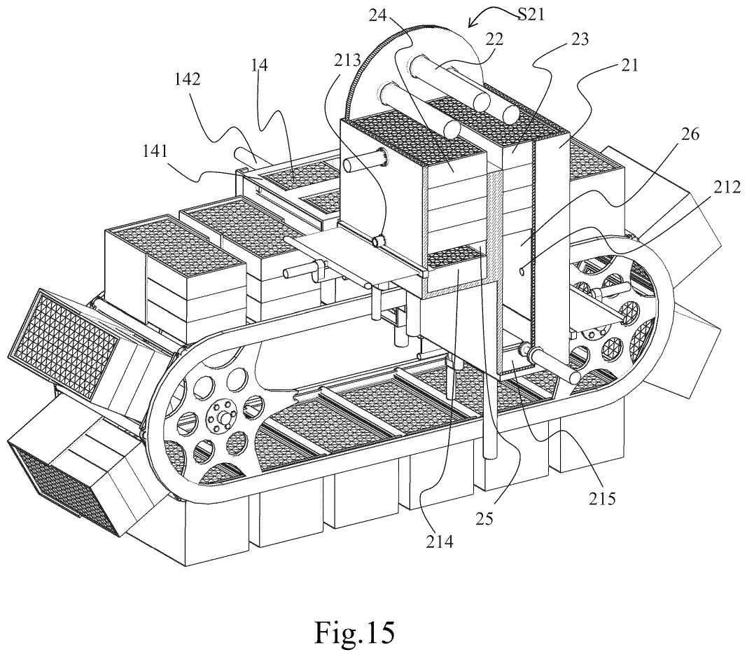

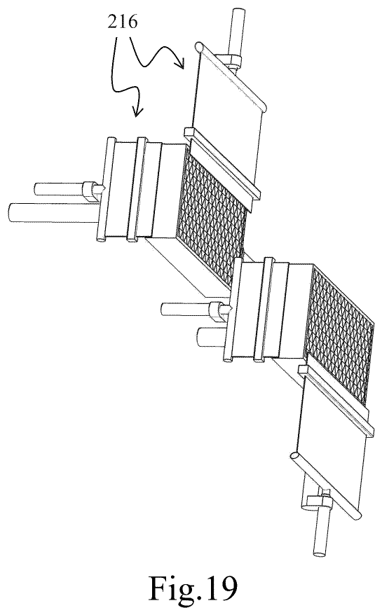

With reference to FIGS. 15, 18, and 19, the regeneration section S2 is provided with the desorption module S21 including the desorption module housing 21, the desorption gas inlet 212, the desorption gas outlet 213, the desorption gas heater 22, the adsorption unit desorption column 23, the adsorption unit heat recovery column 24, the adsorption unit receiving channel 25, and the adsorption unit sending channel 26. The adsorption unit receiving channel 25 of the desorption module S21 of the regeneration section S2 is docked with the adsorption unit transfer-out site 14 of the adsorption section S1 by means of a receiving transition chamber 214. The adsorption unit sending channel 26 of the desorption module S21 of the regeneration section S2 is docked with the adsorption unit transfer-in site 13 of the adsorption section S1 by means of a sending transition chamber 215. The receiving transition chamber 214 and the sending transition chamber 215 are respectively provided with transition valves 216 at positions in communication with the housing 12 of the adsorption section S1 and the desorption module housing 21 of the regeneration section S2. The opening and closing of a gate 2161 of the transition valve 216 is actuated by a multi-stage hydraulic push rod 2162.

1. A gas adsorption concentration apparatus, comprising an adsorption section (S1) and a regeneration section (S2), wherein
the adsorption section (S1) comprises two or more adsorption modules (S11) each provided with a plurality of stages of adsorption units (S01), the adsorption unit (S01) is configured as a fixed adsorption bed provided with an adsorbent, and when an adsorption gas containing adsorbates and basic components passes through the adsorption module (S11), the adsorbates are adsorbed by the adsorbent in the adsorption unit (S01);
the regeneration section (S2) comprises at least one desorption module (S21) provided with a plurality of stages of adsorption units (S01), and when a hot desorption gas passes through the desorption module (S21), the adsorbates in the adsorption unit (S01) are desorbed and carried out by the desorption gas; and
wherein the adsorption units (S01) are transferred between the adsorption section (S1) and the regeneration section (S2) by means of an adsorption unit moving device and circulated in adsorption and desorption processes.

2. The gas adsorption concentration apparatus according to claim 1, wherein when the adsorption section (S1) comprises a plurality of adsorption modules (S11), the adsorption modules (S11) are arranged in a parallel connection relationship.

3. The gas adsorption concentration apparatus according to claim 1, further comprising a connection pipeline (S03) provided with a movable joint (S031), wherein the connection pipeline (S03) realizes a series connection of the adsorption units (S01) in each adsorption module (S11) of the adsorption section (S1) and a parallel connection between all the adsorption modules (S11).

4. The gas adsorption concentration apparatus according to claim 1, further comprising a connection pipeline (S03) provided with a movable joint (S031), wherein the connection pipeline (S03) realizes a series connection of the adsorption units (S01) in each desorption module (S21) of the regeneration section (S2) and a parallel connection between all the desorption modules (S21).

5. The gas adsorption concentration apparatus according to claim 1, wherein the adsorption unit moving device has a pattern of a checkerboard-type transport device, the checkerboard-type transport device consists of a plurality of power support wheel moving disks (S02) fixed on the ground in a checkerboard-type distribution and moving rail seats (S011) fixed on the adsorption units (S01) and matching with the power support wheel moving disks (S02), and the moving rail seats (S011) carrying the adsorption units (S01) are moved between the power support wheel moving disks (S02) in two directions perpendicular to each other, thereby realizing the transfer of the adsorption units (S01) between the adsorption section (S1) and the regeneration section (S2) and the transfer of the adsorption units (S01) inside the adsorption module (S11) and the desorption module (S21).

6. The gas adsorption concentration apparatus according to claim 5, wherein a support wheel (S021) of the power support wheel moving disk (S02) is provided with a hydraulic lift cylinder (S022), and the hydraulic lift cylinder (S022) realizes docking and undocking between an adsorption unit joint (S012) and the movable joint (S031) of the connection pipeline (S03) below the adsorption unit joint by controlling lifting of the support wheel (S021).

7. The gas adsorption concentration apparatus according to claim 1, wherein the desorption module is a variable-temperature variable-pressure desorption device.

8. The gas adsorption concentration apparatus according to claim 1, further provided with adsorption unit storage sections respectively arranged on two sides of the adsorption section (S1) and the regeneration section (S2), wherein the adsorption unit storage section removes a saturated adsorption unit that has completed saturated adsorption from the adsorption section (S1), and/or removes a blank adsorption unit that has completed desorption regeneration from the connection pipeline (S03) of the regeneration section (S2) and re-adds the blank adsorption unit into the connection pipeline (S03) as needed.

9. The gas adsorption concentration apparatus according to claim 1, wherein the adsorption section (S1) comprises a housing (12), an adsorption gas inlet (121), an adsorption gas outlet (122), an adsorption array assembly (11), an adsorption unit transfer-in site (13), and an adsorption unit transfer-out site (14); the adsorption array assembly (11) is provided with a plurality of juxtapositional adsorption modules (S11) each comprising at least one layer of the adsorption units (S01); the adsorption array assembly (11) divides a space enclosed by the housing (12) into an inlet gas distribution box (123) and an outlet gas collection box (124); the adsorption gas inlet (121) is in communication with the inlet gas distribution box (123); the adsorption gas outlet (122) is in communication with the outlet gas collection box (124); and a mechanical support and transfer device (112), as a constituent part of the adsorption array assembly (11), supports a movement of the adsorption module (S11) at an adsorption function site, moves the adsorption unit (S01) that has completed adsorption from the adsorption function site in the adsorption module (S11) to the adsorption unit transfer-out site (14), and moves the adsorption unit (S01) that has completed regeneration treatment from the adsorption unit transfer-in site (13) to the adsorption function site in the adsorption module (S11).

10. The gas adsorption concentration apparatus according to claim 9, wherein the adsorption module (S11) comprises a plurality of layers of the adsorption units (S01); an end of the adsorption module (S11) located on a side of the inlet gas distribution box (123) is referred to as a head end (1111), and an end located on a side of the outlet gas collection box (124) is referred to as a tail end (1112); the mechanical support and transfer device (112) moves the adsorption unit (S01) from the head end (1111) to the adsorption unit transfer-out site (14) and moves the adsorption unit (S01) that has completed the regeneration treatment from the adsorption unit transfer-in site (13) to the tail end (1112); and the adsorption unit (S01) moves from the tail end (1112) to the head end (1111) in the adsorption module (S11).

11. The gas adsorption concentration apparatus according to claim 9, wherein the desorption module (S21) of the regeneration section (S2) comprises a desorption module housing (21), a desorption gas inlet (212), a desorption gas outlet (213), a desorption gas heater (22), an adsorption unit desorption column (23), an adsorption unit heat recovery column (24), an adsorption unit receiving channel (25), an adsorption unit sending channel (26), and a corresponding mechanical moving device; the desorption gas from a desorption gas supply apparatus (27) passes through the desorption module (S21) according to an order of the desorption gas inlet (212)—the adsorption unit heat recovery column (24)—the desorption gas heater (22)—the adsorption unit desorption column (23)—the desorption gas outlet (213), to reach a desorption gas treatment device; and the mechanical moving device moves the adsorption unit (S01) in the desorption module (S21) according to an order of the adsorption unit receiving channel (25)—the adsorption unit desorption column (23)—the adsorption unit heat recovery column (24)—the adsorption unit sending channel (26).

12. The gas adsorption concentration apparatus according to claim 11, wherein the adsorption unit receiving channel (25) and the adsorption unit sending channel (26) of the regeneration section (S2) are respectively docked with the adsorption unit transfer-out site (14) and the adsorption unit transfer-in site (13) of the adsorption section (S1), the adsorption gas and the desorption gas are isolated from each other at docking positions by means of transition chambers (214, 215), and the transition chambers are connected between the adsorption section (S1) and the regeneration section (S2) and each provided with valves (216) on two sides.

13. The gas adsorption concentration apparatus according to claim 12, wherein the adsorption array assembly (11) has a sprocket structure, and each adsorption module (S11) acts as an attachment of a link of the sprocket structure and rotates cyclically on the sprocket structure.

14. The gas adsorption concentration apparatus according to claim 13, wherein the number of links of the sprocket structure is determined based on a flow rate of the adsorption gas, to adjust the number of the adsorption modules (S11).

15. The gas adsorption concentration apparatus according to claim 14, wherein the desorption module (S21) is set to be an inverted U-shaped structure, with the desorption gas heater (22) located at an upper portion thereof, and the adsorption unit desorption column (23) and the adsorption unit heat recovery column (24) respectively located at lower portions on two sides thereof.
